(19) United States
(12) Patent Application Publication
(10) Pub. No.: US 2013/0250581 A1
(43) Pub. Date: Sep. 26, 2013

(54) AMPLIFIED CONDENSING LED LIGHT LENS AND MODULE THEREOF

(71) Applicants: TE-LUNG TANG, NEW TAIPEI CITY (TW); YU-CHE LO, NEW TAIPEI CITY (TW)

(72) Inventors: TE-LUNG TANG, NEW TAIPEI CITY (TW); YU-CHE LO, NEW TAIPEI CITY (TW)

(73) Assignees: LEDLINK OPTICS, INC., NEW TAIPEI CITY (TW); YANG ZHOU LEDLINK OPTICS CO., LTD., JIANGSU PROVINCE (CN); LEDLINK OPTICS (DONG GUAN) CO. LTD., GUANGDONG (CN)

(21) Appl. No.: 13/532,898

(22) Filed: Jun. 26, 2012

(30) Foreign Application Priority Data
Mar. 23, 2012 (TW) 101110103

(51) Int. Cl. F21V 5/04

(52) U.S. Cl. 362/311.02; 362/335

(57) ABSTRACT

An amplified condensing LED light lens and a module thereof are disclosed. The lens is a downwardly tapered cup structure having a first light-incident surface and a second light-incident surface concavely disposed at the bottom of the amplified condensing LED light lens to form a containing space and a light-incident hole, and the containing space is provided for containing a light emitting source, and a residual light blocking structure is protruded from the first light-incident surface for blocking a residual light of the light emitting source. If the distance between the first light-incident surface and the light-incident hole is S, the distance between the bottom of the residual light blocking structure and the light-incident hole is L, 0<L<(⅜)*S, and S≧0.8*D, the residual light blocking structure can hinder the occurrence of a residual light phenomenon caused by the reflection of the light emitting source from the second light-incident surface.

### CROSS-REFERENCE TO RELATED APPLICATIONS

This non-provisional application claims priority under 35 U.S.C. §119(a) on Patent Application No(s). 101110103 filed in Taiwan, R.O.C. on Mar. 23, 2012, the entire contents of which are hereby incorporated by reference.

### BACKGROUND OF THE INVENTION

1. Field of the Invention

The present invention relates to the technical field of optical lenses, in particular to an amplified condensing LED light lens and a module with the amplified condensing LED light lens thereof used for passing a light emitted from a light emitting source through the amplified condensing LED light lens with a residual light blocking structure to hinder the occurrence of a residual light phenomenon effectively.

2. Description of the Related Art

To adjust the illumination effect of using light emitting diode (LED) as a light emitting source in different fields, related manufacturers generally covers an optical lens onto the top of the LED, so that the light emitted from the LED is passed through the optical lens to produce various different light patterns with better applicability. For example, characteristics including the light intensity, light uniformity and illumination range of a LED lamp can be improved for the application of LED in the field of illumination. With reference to FIGS. 1 to 3 for a cross-sectional view of a conventional LED optical lens, a schematic view of a residual light track produced after a LED light source passes through the conventional optical lens, and an irradiance diagram of a LED light source passing through the conventional optical lens respectively, the optical lens 1 is an optical component integrally made of a transparent material such as silicone, acrylic, polycarbonate or glass, and the optical lens 1 is substantially a downwardly tapered cup structure having a light-exiting surface 10 at an end of the optical lens 1 and a first light-incident surface 11 and a second light-incident surface 12 concavely disposed at the other end of the optical lens 1. Wherein, a periphery of the first light-incident surface 11 is coupled to a lateral side of the second light-incident surface 12 to define a containing space, and the other lateral side of the second light-incident surface 12 is wound to form a light-incident hole 13, and the containing space is provided for containing a light emitting diode, LED (not shown in the figure), so that the first light-incident surface 11 is disposed at the top of the LED and the second light-incident surface 12 is surrounded around the periphery of the LED. However, after the conventional optical lens 1 is coupled to the LED, it is inevitable to have a residual light phenomenon occurred in the illumination light pattern, which hinders the following use. The so-called “residual light phenomenon” refers to a light distribution phenomenon existing in areas other than the target illumination area. The cause of the residual light phenomenon resides on a small portion of light of the LED projecting onto the second light-incident surface 12 to produce a first reflection, and then to produce a second reflection at an inner side of the optical lens 1, and finally exiting the light-exiting surface 10 to produce a halo distribution at the neighborhood of an area other than the central illumination area as shown in FIG. 3. Therefore, it is a main subject for the present invention to overcome the problems of the prior art and hinder the occurrence of the residual light phenomenon effectively.

### SUMMARY OF THE INVENTION

In view of the drawbacks of the prior art, it is a primary objective of the present invention to provide an amplified condensing LED light lens and a module with the amplified condensing LED light lens thereof capable of preventing the residual light phenomenon, such that after a LED light source passes through the amplified condensing LED light lens of the present invention, a better light pattern can be obtained and provided for various different applications including the field of illuminations.

To achieve the foregoing objective, the present invention provides an amplified condensing LED light lens being a downwardly tapered cup structure, and having a light-exiting surface disposed at the top of the amplified condensing LED light lens, and a first light-incident surface and a second light-incident surface concavely formed at the bottom of the amplified condensing LED light lens, and a lateral side of the first light-incident surface being coupled to a lateral side of the second light-incident surface to define a containing space for containing a light emitting source, and the other lateral side of the second light-incident surface being wound to form a light-incident hole, and the light-incident hole having a width of D, characterized in that the amplified condensing LED light lens comprises a residual light blocking structure protruded from the first light-incident surface and provided for blocking a residual light emitted from the light emitting source and reflected by the second light-incident surface; wherein the distance between the first light-incident surface and the light-incident hole is S, and the distance between the bottom of the residual light blocking structure and the light-incident hole is L, and the distance of the residual light blocking structure from the light-incident hole satisfies the relations of 0<L<(⅜)*S and S≧0.8*D.

Wherein, the residual light blocking structure is an inverted conical structure formed by extending and tapering the first light-incident surface in a direction towards the light-incident hole. To cope with various different types of light sources, the surface of the residual light blocking structure can be designed in a convex arc shape, a concave arc shape, a planar shape or a curved shape to achieve the light pattern requirements or the residual light hindering effect. Further, the residual light blocking structure has a surface which is a frosted mist surface to enhance the effect of hindering the occurrence of the residual light phenomenon.

In addition, the light-exiting surface further includes a material evacuated hole concavely formed thereon and having a size corresponding to the first light-incident surface for overcoming the drawback of having a stronger light intensity at the central area of the light emitting source and a less uniform light effect. With the material evacuated hole, the occurrence of the residual light phenomenon can be hindered effectively, and the uniform light effect of the target illumination area can be enhanced effectively. The present invention can broaden the scope of applicability of the lens significantly.

To achieve the foregoing objective, the present invention further provides a module with the amplified condensing LED light lens, being a downwardly tapered cup structure, and having a light-exiting surface disposed at the top of the amplified condensing LED light lens, a first light-incident surface and a second light-incident surface concavely disposed at the bottom of the amplified condensing LED light lens, and a first light-incident surface and a second light-incident surface concavely formed at the bottom of the amplified condensing LED light lens, and a lateral side of the first light-incident surface being coupled to a lateral side of the second light-incident surface to define a containing space, and the containing space having a light emitting source disposed thereon, and the other lateral side of the second light-incident surface being wound to form a light-incident hole, characterized in that the amplified condensing LED light lens comprises a residual light blocking structure protruded from the first light-incident surface and provided for blocking a residual light emitted from the light emitting source and reflected by the second light-incident surface, wherein the distance between the bottom of the residual light blocking structure and the light emitting source is L″, and a light is emitted from the light emitting source and reflected by the second light-incident surface to a central axis of the module the amplified condensing LED light lens to form a central reflection point, and the distance between the central reflection point and the light emitting source is P, and the distance from the bottom of the residual light blocking structure to the light emitting source satisfies the relation of L″≦P.

In the module with the amplified condensing LED light lens of the present invention, the size of the residual light blocking structure is adjusted according to the relative position of the installed light emitting source, so that the light pattern emitted from the lens with a residual light blocking module can be free of the residual light phenomenon.

### BRIEF DESCRIPTION OF THE DRAWINGS

FIG. 1 is a cross-sectional view of a conventional LED optical lens;

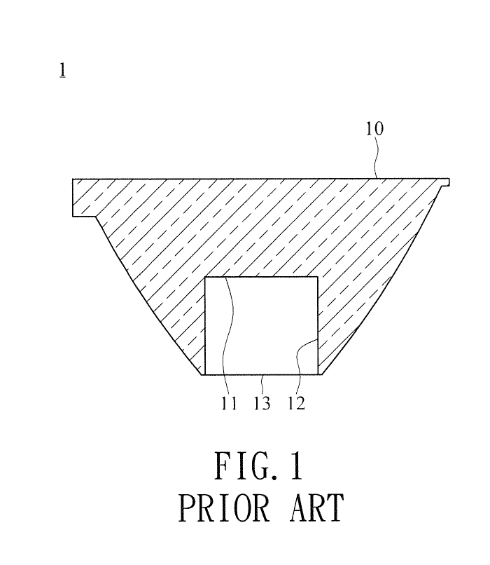

FIG. 2 is a schematic view of a residual light track produced after a LED light source passes through a conventional optical lens;

FIG. 3 is an irradiance diagram of a LED light source passing through a conventional optical lens;

FIG. 4 is a cross-sectional view of an amplified condensing LED light lens in accordance with a preferred embodiment of the present invention;

FIG. 5 is a schematic view of a residual light track after a LED is combined in accordance with a preferred embodiment of the present invention;

FIG. 6 is an irradiance diagram of a LED after the LED is combined in accordance with a preferred embodiment of the present invention;

FIG. 7 is a light distribution curve of a LED after the LED is combined in accordance with a preferred embodiment of the present invention;

FIG. 8 is a schematic view of a residual light track of a LED combined in accordance with another preferred embodiment of the present invention;

FIG. 9 is an irradiance diagram of a LED after the LED is combined in accordance with another preferred embodiment of the present invention;

FIG. 10 is a light distribution curve of a LED after the LED is combined in accordance with another preferred embodiment of the present invention;

FIG. 11 is a schematic view of the amplified condensing LED light lens in accordance with a further preferred embodiment of the present invention; and

FIG. 12 is a cross-sectional view of a module with the amplified condensing LED light lens in accordance with a preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

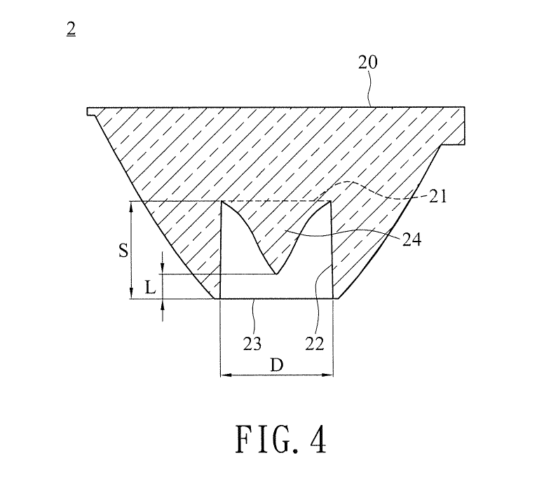

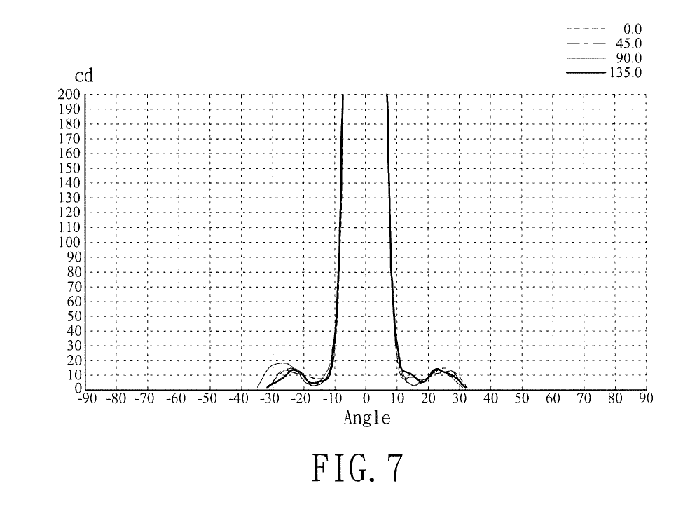

With reference to FIGS. 4 to 7 for a cross-sectional view of an amplified condensing LED light lens in accordance with a preferred embodiment of the present invention, a schematic view of a residual light track after a LED is combined in accordance with a preferred embodiment of the present invention, an irradiance diagram of a LED after the LED is combined in accordance with a preferred embodiment of the present invention, and a light distribution curve of a LED after the LED is combined in accordance with a preferred embodiment of the present invention respectively, the amplified condensing LED light lens 2 is integrally made of a transparent material such as silicone, acrylic, polycarbonate or glass, and the amplified condensing LED light lens 2 is provided for the use of combining with a light emitting source (not shown in the figure) and guiding a light emitted from the light emitting source through the present invention to form a better light pattern distribution, so as to hinder the occurrence of a residual light phenomenon effectively. The amplified condensing LED light lens 2 is a downwardly tapered cup structure having a light-exiting surface 20 at the top, and a first light-incident surface 21 and a second light-incident surface 22 concavely disposed at the bottom, and a lateral edge of the first light-incident surface 21 is coupled to a lateral edge of the second light-incident surface 22 to define a containing space for containing the light emitting source, and the other lateral edge of the second light-incident surface 22 is enclosed to form a light-incident hole 23, and the light-incident hole 23 has a width D, characterized in that a residual light blocking structure 24 is protruded from the first light-incident surface 21 of the amplified condensing LED light lens 2 and provided for blocking a residual light emitted from the light emitting source and reflected by the second light-incident surface 22. To effectively block the residual light while maintaining a uniform lighting effect, the residual light blocking structure 24 is installed and extended in a direction from the first light-incident surface 21 towards the light-incident hole 23 and tapered to form an inverted conical structure. For example, the LED is used as the light emitting source, and the residual light blocking structure 24 substantially in form of an inverted conical structure is generally installed at a central light emitting area of the LED with the greater light intensity and provided for adjusting the light emission. Therefore, the light emitted from the LED can be passed through the present invention to form a light pattern capable of hindering the occurrence of a residual light phenomenon effectively, while improving the light uniformity of the light pattern significantly. The so-called “residual light phenomenon” is caused by the reflection of a small portion of the light emitting source that passes through the second light-incident surface 22. To assure the effect of blocking the residual light, the size of the residual light blocking structure 24 with respect to the amplified condensing LED light lens 2 of the present invention must satisfy a certain condition before achieving the desired effect. Assumed that the distance between the first light-incident surface 21 and the light-incident hole 23 is equal to S, and the distance between the bottom of the residual light blocking structure 24 and the light-incident hole 23 is equal to L, the distance between the residual light blocking structure 24 and the light-incident hole 23 satisfies the conditions of 0<L<(⅜)*S and S≧0.8*D. For different types of light sources, light patterns or required residual light blocking effects, the surface of the residual light blocking structure 24 can be designed in a convex arc-shape, a concave arc-shape, a planar shape, or a curved shape, such that the small portion of light passing through the second light-incident surface 22 and reflected to the residual light blocking structure 24 may have different refractions from the convex arc-shaped, concave arc-shaped, planar shaped, or curved shaped surface, so as to affect the light pattern performance of the exiting light. Therefore, the surface of the residual light blocking structure 24 can be designed to provide a fine light pattern adjustment or change. To enhance the effect of hindering the occurrence of the residual light phenomenon, the surface of the residual light blocking structure can be made as a frosted mist surface, and its purposes and reasons are the same as those described above, and thus will not be repeated.

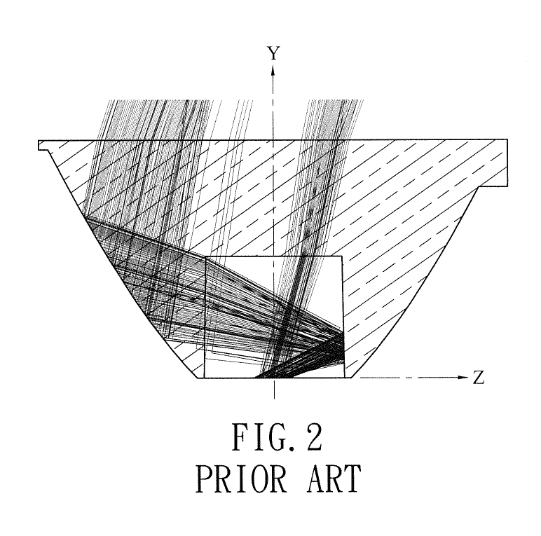

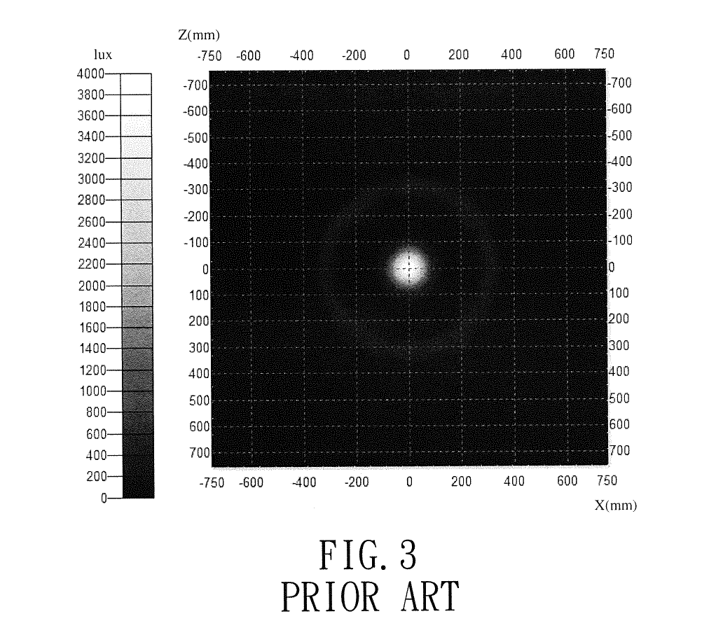

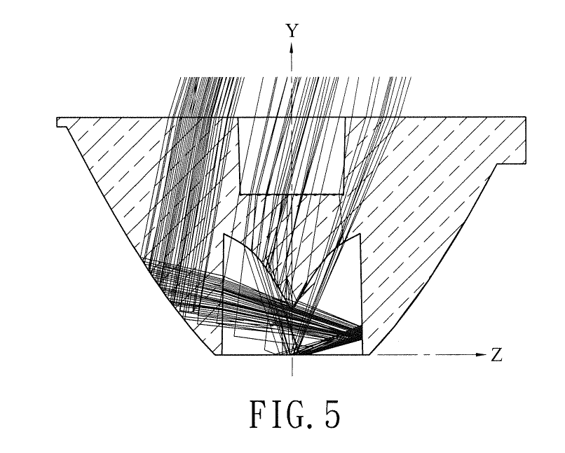

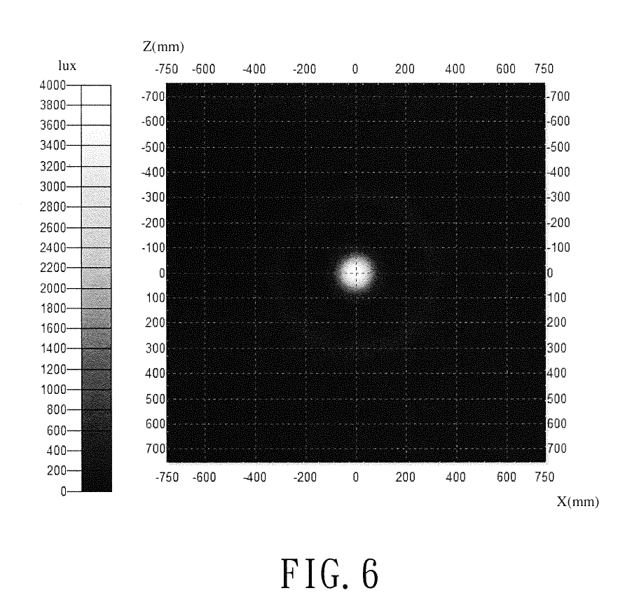

With reference to FIGS. 2 and 3 for the prior art and FIGS. 5 to 7 for the present invention again, if the conditions 0<L<(⅜)*S and S≧0.8*D are satisfied, experimental results show that a small portion of the light reflected from the second light-incident surface 22 is blocked by the residual light blocking structure 24, provided that S=13.00 mm, D=15.00 mm and L=4.80 mm. By comparing the quantities of light reflected from the light-exiting surface 20 as shown in FIGS. 2 and 5, we can observe that the quantity of light as shown in FIG. 5 is reduced much more than that as shown in FIG. 2. By comparing the halos in area other than the target illumination areas as shown in FIGS. 6 and 3, we can observe a more significant reduction in FIG. 6 that in FIG. 3, and these tendencies are supported by the corresponding light distribution curve corresponding to FIG. 5. Compared with the prior art, the residual light blocking structure 24 of the present invention satisfying the aforementioned relations can achieve the effect of hindering the occurrence of the residual light phenomenon. It is noteworthy that the diagram of the prior art (FIG. 2) or the diagram of the residual light track of the present invention (FIG. 5) are simply drawn based on the light of the residual light phenomenon only and corresponding to FIG. 3 or the irradiation diagram (FIG. 6). Wherein, the residual light phenomenon as shown in FIG. 2 or FIG. 5 refers to the distribution of halos at the outer periphery of areas other than the central target illumination area as depicted in FIG. 3 or 6.

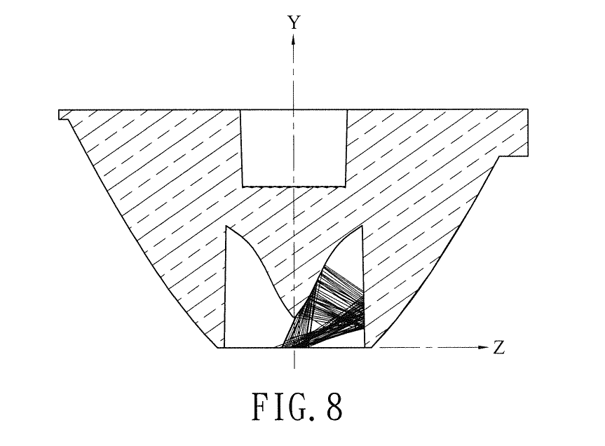

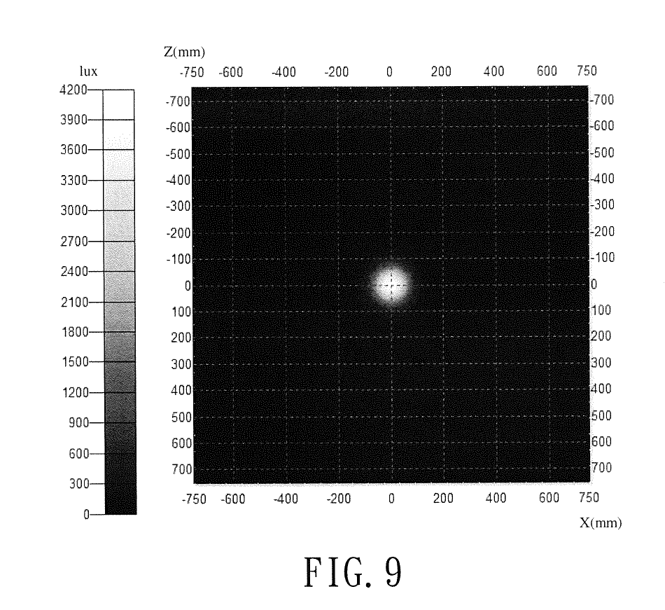

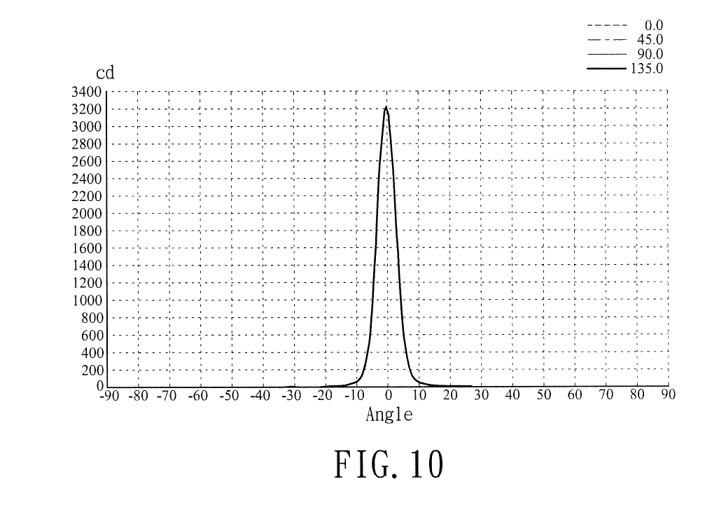

With reference to FIGS. 8 to 10 for a schematic view of a residual light track and an irradiance diagram and a light distribution curve of a LED after the LED is combined in accordance with another preferred embodiment of the present invention respectively, if 0<L<(⅜)*S and S≧0.8*D, experimental results show that if S=13.00 mm, D=15.00mm and L=3.25 mm, a small portion of light reflected from the second light-incident surface 22 is almost completely blocked by the residual light blocking structure 24. Therefore, the corresponding irradiance diagram (as shown in FIG. 9) and light distribution curve (as shown in FIG. 10) indicate that the halos outside the target illumination area almost disappear completely. Compared with the prior art, the residual light blocking structure 24 of the invention satisfying the aforementioned relations can achieve the effect of hindering the occurrence of the residual light phenomenon. The smaller the value of L, the better is the effect of hindering the residual light.

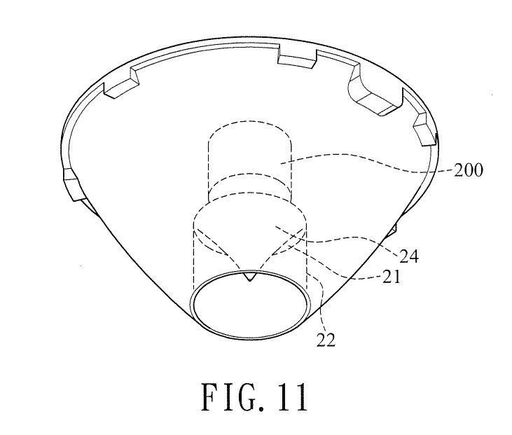

With reference to FIG. 11 for a schematic view of the amplified condensing LED light lens in accordance with a further preferred embodiment of the present invention, the structure of this preferred embodiment is substantially the same as those described above, and thus the same structure will not be repeated, and only the difference will be highlighted. In this preferred embodiment, a material evacuated hole 200 is concavely formed on the light-exiting surface 20, and the material evacuated hole 200 is designed according to the position and the size of the first light-incident surface 21 and provided for improving the drawbacks of having a stronger light intensity at the central area of the light emitting source and a less light uniformity. With the aforementioned structure, the present invention can eliminate the occurrence of residual light phenomenon, and achieve the effects of enhancing the light uniformity of the target illumination area and broadening the scope of applicability of the amplified condensing LED light lens 2.

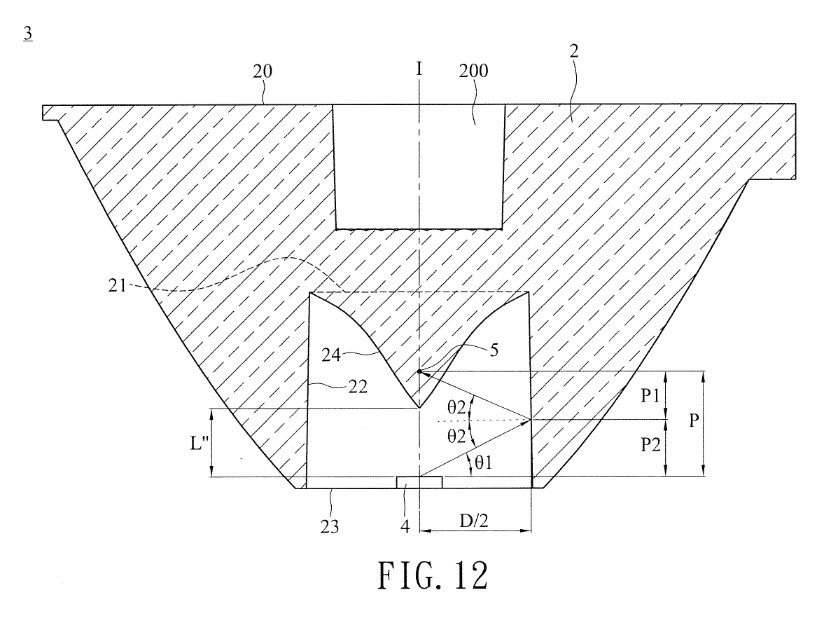

With reference to FIG. 12 for a cross-sectional view of a module with the amplified condensing LED light lens 3 with a preferred embodiment of the present invention, the module with the amplified condensing LED light lens 3 is a downwardly tapered cup structure having a light-exiting surface 20 at the top of the amplified condensing LED light lens 2, and a first light-incident surface 21 and a second light-incident surface 22 concavely formed at the bottom of the amplified condensing LED light lens 2, and a lateral side of the first light-incident surface 21 is coupled to a lateral side of the second light-incident surface 22 to define a containing space, and the containing space has a light emitting source 4 disposed therein and the other lateral side of the second light-incident surface 22 is wound to form a light-incident hole 23, characterized in that a residual light blocking structure 24 is protruded from the first light-incident surface 21 of the module with the amplified condensing LED light lens 3 and provided for blocking a residual light emitted from the light emitting source 4 and reflected by the second light-incident surface 22, wherein the distance between the bottom of the residual light blocking structure 24 and the light emitting source 4 is L″, and a light is emitted by the light emitting source 4 and reflected from the second light-incident surface 22 to a central axis I of the module with the amplified condensing LED light lens 3 to form a central reflection point 5, and the distance between the central reflection point 5 and the light emitting source 4 is P, and the distance between the bottom of the residual light blocking structure 24 and the light emitting source satisfies the relation of L″≦P. Therefore, the module with the amplified condensing LED light lens 3 of this preferred embodiment can adjust the size of the residual light blocking structure 24 according to the relative position of the installed light emitting source 4, so that the light pattern emitted from the module with the amplified condensing LED light lens 3 can be free of the residual light phenomenon. Firstly, the module with the amplified condensing LED light lens 3 uses the residual light blocking structure 24 to change an optical diameter of a side light of the light emitting source 4 and the energy loss of the residual light, so as to eliminate the unnecessary residual light substantially. Therefore, after a small portion of light of the light emitting source 4 is emitted at an angle θ₁ (such as an angle greater than 0 degree and less than or equal to 60 degrees) to the second light-incident surface 22, a central reflection point 5 is formed by reflecting the light at an angle at θ₂ with respect to the second light-incident surface 22 to the central axis I, so that the central reflection point 5 is situated on the central axis I, and the distance from the central reflection point 5 to the light emitting source 4 is P, and P=P₁+P₂, and P₂=(D/2)*tan θ₁, and P₁=(D/2)*tan(2θ₂−θ₁), D is the width of the light-incident hole 23. So that, P=(D/2)*(tan(2θ₂−θ₁)+tan θ₁)). In other words, the distance L″ from the bottom of the residual light blocking structure 24 to the light emitting source 4 is smaller than P, so that the interference of the residual light on the distribution of optical diameter can be prevented. Even if L″ is reduced further, the effect of hindering the residual light will not be affected. Therefore, the module with the amplified condensing LED light lens 3 of this preferred embodiment can be implemented by the aforementioned concept. Since the distance P depends on the width D of the light-incident hole 23 and the angle of reflection θ₂ at the second light-incident surface 22. Therefore, this preferred embodiment can use the relation of P=(D/2)*(tan(2θ₂−θ₁)+tan θ₁)) to adjust the relative size of the residual light blocking structure 24 effectively to hinder the occurrence of the residual light phenomenon.

What is claimed is:

1. An amplified condensing LED light lens, being a downwardly tapered cup structure, and having a light-exiting surface disposed at the top of the amplified condensing LED light lens, and a first light-incident surface and a second light-incident surface concavely formed at the bottom of the amplified condensing LED light lens, and a lateral side of the first light-incident surface being coupled to a lateral side of the second light-incident surface to define a containing space for containing a light emitting source, and the other lateral side of the second light-incident surface being wound to form a light-incident hole, and the light-incident hole having a width of D, characterized in that the amplified condensing LED light lens comprises a residual light blocking structure protruded from the first light-incident surface and provided for blocking a residual light emitted from the light emitting source and reflected by the second light-incident surface; wherein the distance between the first light-incident surface and the light-incident hole is S, and the distance between the bottom of the residual light blocking structure and the light-incident hole is L, wherein 0<L<(⅜)*S and S≧0.8*D.

2. The amplified condensing LED light lens as recited in claim 1, wherein the residual light blocking structure is an inverted conical structure formed by extending and tapering the first light-incident surface in a direction towards the light-incident hole.

3. The amplified condensing LED light lens as recited in claim 2, wherein the residual light blocking structure has a surface substantially in a convex arc shape, a concave arc shape, a planar shape or a curved shape.

4. The amplified condensing LED light lens as recited in claim 3, wherein the residual light blocking structure has a surface which is a frosted mist surface.

5. The amplified condensing LED light lens as recited in claim 1, wherein the light-exiting surface has a material evacuated hole concavely formed thereon.

6. The amplified condensing LED light lens as recited in claim 2, wherein the light-exiting surface has a material evacuated hole concavely formed thereon.

7. The amplified condensing LED light lens as recited in claim 3, wherein the light-exiting surface has a material evacuated hole concavely formed thereon.

8. The amplified condensing LED light lens as recited in claim 4, wherein the light-exiting surface has a material evacuated hole concavely formed thereon.

9. A module with an amplified condensing LED light lens, being a downwardly tapered cup structure, and having a light-exiting surface disposed at the top of the amplified condensing LED light lens, and a first light-incident surface and a second light-incident surface concavely formed at the bottom of the amplified condensing LED light lens, and a lateral side of the first light-incident surface being coupled to a lateral side of the second light-incident surface to define a containing space, and the containing space having a light emitting source disposed thereon, and the other lateral side of the second light-incident surface being wound to form a light-incident hole, characterized in that the amplified condensing LED light lens comprises a residual light blocking structure protruded from the first light-incident surface and provided for blocking a residual light emitted from the light emitting source and reflected by the second light-incident surface, wherein the distance between the bottom of the residual light blocking structure and the light emitting source is L″, and a light is emitted from the light emitting source and reflected by the second light-incident surface to a central axis of the module with the amplified condensing LED light lens to form a central reflection point, and the distance between the central reflection point and the light emitting source is P, wherein L″≦P.
